(19) United States
(12) Patent Application Publication
(10) Pub. No.: US 2007/0071192 A1
(43) Pub. Date: Mar. 29, 2007

(54) System and method of event triggered voice call origination

(75) Inventors: Charles Eric Smith, Austin, TX (US); Chris Tooley, Blanco, TX (US); Lanny Wayne Walker, Austin, TX (US); James Edward Butcher, Round Rock, TX (US); Roy Stacey Zuniga, Austin, TX (US)

Correspondence Address: TOLER SCHAFFER, LLP, 5000 PLAZA ON THE LAKES, SUITE 265, AUSTIN, TX, 78746, US

(73) Assignee: gNumber, Inc., Austin, TX (US)

(21) Appl. No.: 11/228,887

(22) Filed: Sep. 16, 2005

(51) Int. Cl. H04M 11/00

(52) U.S. Cl. 379/93.12

(57) ABSTRACT

A method is disclosed and includes presenting a list of items for sale. The method also includes receiving a user selection of an item from the list of items for sale and placing the selected item on an action list in response to a user action. Additionally, the method includes monitoring the selected item on the action list and placing a call to the user over a voice channel before an end of an offer for sale of the selected item. The method also includes authenticating the user. In an alternative embodiment, the method includes instructing a third party to place a call to the user before the end of the offer for sale of the selected item.

### FIELD OF THE DISCLOSURE

The present disclosure relates to event triggered communications.

### BACKGROUND

As of May 2005, the Cellular Telecommunications Industry Association (CTIA) estimates that there are 182 million wireless subscribers in the United States. Further, the CTIA estimates that over 2.5 billion text messages are sent every month. Text messages, sent via short messaging service (SMS), are currently used by Internet companies to deliver notifications to mobile telephones. Unfortunately, text messaging is not secure, does not provide guaranteed delivery, is not free, and is not sent in real-time.

Regarding security issues, programs have been provided that can enable someone to spoof a sender's SMS address. Further, since SMS messages are “store and forward” based systems, there is no guarantee that sent SMS messages are received within any particular timeframe. As such, some SMS providers present a disclamer to their users that the provider is not responsible for messages that are lost or significantly delayed due to transmission via the Internet. Also, unlike voice calling plans, there currently are no “nights and weekends free” service plans for SMS messaging.

For certain e-commerce websites, e.g., on-line auction sites, text messaging is not a very efficient way to interact with bidders of items because the auctions are typically fast paced and require confirmed delivery of bids. Further, the auction sites may utilize instant feedback for usability and understanding of the system.

Accordingly, there is a need for an improved system and method of communicating with e-commerce websites, e.g., auction websites.

### BRIEF DESCRIPTION OF THE DRAWINGS

FIG. 1 is a block diagram representing a system of facilitating e-commerce;

FIG. 2 is a flow chart illustrating a method of establishing a user account with a vender website monitoring system;

FIG. 3 is a flow chart illustrating a general method of monitoring a vender website;

FIG. 4 is a flow chart illustrating a detailed method of contacting a registered user about an auction website;

FIG. 5 is a flow chart illustrating a detailed method of contacting a registered user about an e-commerce website;

FIG. 6 is a flow chart illustrating a method of establishing a user account with a vender system;

FIG. 7 is a flow chart illustrating a detailed method of contacting a registered user about a product available at a vender website;

FIG. 8 is a flow chart illustrating an alternative detailed method of contacting a registered user about a product available at a vender website;

FIG. 9 is a flow chart illustrating another alternative detailed method of contacting a registered user about a product available at a vender website;

FIG. 10 is a general diagram of a first registration screen;

FIG. 11 is a general diagram of a second registration screen; and

FIG. 12 is a general diagram of a third registration screen.

### DETAILED DESCRIPTION OF THE DRAWINGS

A method is disclosed and includes presenting a list of items for sale. The method also includes receiving a user selection of an item from the list of items for sale and placing the selected item on an action list in response to a user action. Additionally, the method includes monitoring the selected item on the action list and placing a call to the user over a voice channel before an end of an offer for sale of the selected item. The method also includes authenticating the user. In an alternative embodiment, the method includes instructing a third party to place a call to the user before the end of the offer for sale of the selected item.

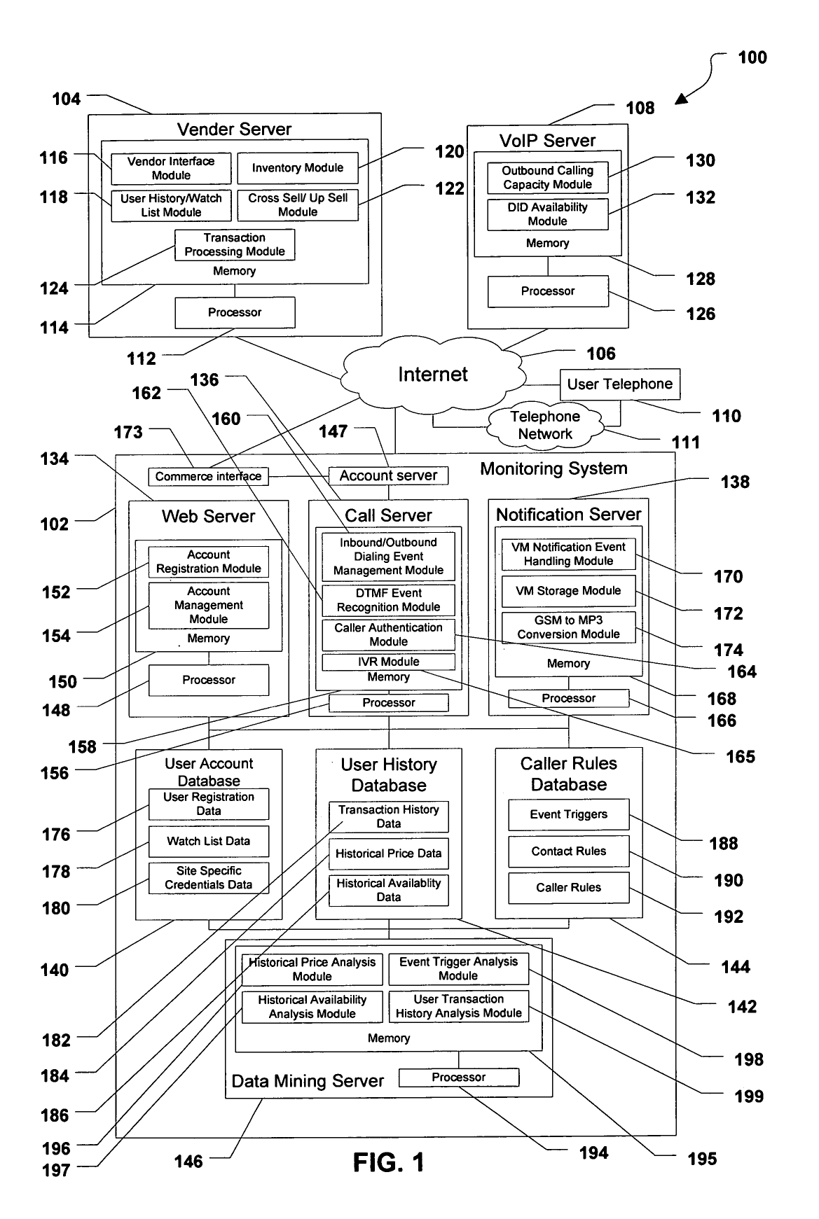

Referring to FIG. 1, a system of facilitating e-commerce is shown and is designated 100. As shown, the system 100 includes a monitoring system 102 that communicates with a vender server 104 via the Internet 106. Further, the monitoring system 102 communicates with a voice over Internet protocol (VoIP) server 108 via the network 106. In a particular embodiment, a user telephone 110 is coupled to the monitoring system 102 via the Internet 106. Further, the user telephone 110 can be coupled to the Internet 106 via a telephone network 111, e.g., a public switched telephone network (PSTN) or a wireless telephone network, such as global system for mobile communication (GSM) network.

In a particular embodiment, the vender server 104 can be an e-commerce server that offers goods for sale with fixed pricing or escalating pricing based on an auction format. As shown, the vender server 104 can include a processor 112 and a memory 114 coupled to the processor 112. In a particular embodiment, one or more software applications or modules may be embedded within the memory 114 of the vender server 104. For example, the vender server 104 can include a vender interface module 116 embedded within the memory 114. The vender interface module 116 can provide connectivity with the vender server 104, e.g., via the Internet 106. In an illustrative embodiment, the vender server 104 also includes a user history/watch list module 118 than can be used to track the shopping or bidding history of one or more users and items that one or more user are seeking to purchase.

As shown in FIG. 1, the vender server 104 can further include an inventory module 120 that can be used to track the inventory provided for sale via the vender server 104. Further, the vender server 104 can include a cross sell/up sell module 122 that can be used to increase the sales provided by the vender server 104. For example, when a user purchases a particular item, the cross sell/up sell module 122 can recognize related items that may be useful to the user and offer those related items to the user for sale in conjunction with a purchased item. FIG. 1 also shows that the vender server 104 can include a transaction processing module 124 for processing transactions with the vender server 104.

As depicted in FIG. 1, the VoIP server 108 can include a processor 126 and a memory 128 that is accessible to the processor 126. In a particular embodiment, one or more software applications or modules may be embedded within the memory 128 of the VoIP server 108. For example, as shown, an outbound calling capacity module 130 can be embedded within the memory. In a particular embodiment, the outbound calling capacity module 130 can determine the number of outbound calls that the VoIP server 108 is capable of establishing at any given time. FIG. 1 also indicates that the VoIP server 108 can include a direct inward dialing (DID) availability module 132 that is embedded within the memory 128 of the VoIP server 108. In an illustrative embodiment, the DID availability module 132 can determine whether direct inward dialing is available for a particular user and if so, a DID service can be use to identify a called party, e.g., by using DTMF or other signaling means, before connecting a call to a called party.

FIG. 1 illustrates that the monitoring system 102 includes a web server 134, a call server 136, and a voice mail notification server 138. Additionally, the monitoring system 102 includes a user account database 140, a user history database 142, and a caller rules database 144. Each of the databases 140, 142, 144 can be coupled to one or more of the servers 134, 136, 138 within the monitoring system 102. FIG. 1 also indicates that the monitoring system 102 can includes a data mining server 146 that can be coupled to the databases 140, 142, 144. Additionally, an account server 147 can be coupled to the call server 136.

In a non-limiting, exemplary embodiment, the web server 134 includes a processor 148 and a computer readable medium, e.g., a memory 150, that is accessible to the processor 148. In a particular embodiment, one or more software applications or modules may be embedded within the memory 150 of the web server 134. For example, an account registration module 152 and an account management module 154 can be embedded within the memory 150 of the web server 134. In a particular embodiment, the modules 152, 154 can be used to allow one or more users to establish user accounts with the monitoring system 102. Further, the modules 152, 154 can be used to allow users to configure multiple user accounts on a per-vender basis and configure one or more notification events, or trigger events, on a per-vender basis.

Additionally, in a particular embodiment, the modules 152, 154 can be used to allow one or more users to update contact information, or notification information, previously input to the monitoring system. The contact information can include alternate numbers at which a user can be reached, e.g., a home telephone number, a work telephone number, and a mobile telephone number. Also, in a particular embodiment, the modules 152, 154 can allow users to configure call security settings for the user accounts, e.g., the modules 152, 154 can allow each user to establish a personal identification number (PIN) with the system and each user can be prompted to input a PIN when contacted by the monitoring system 102.

As illustrated in FIG. 1, the call server 136 within the monitoring system 102 can include a processor 156 and a computer readable medium, e.g., a memory 158, that is accessible to the processor 156. In a particular embodiment, one or more software applications or modules may be embedded within the memory 158 of the call server 136. For example, an inbound/outbound dialing event management module 160 may be embedded within the memory 158. Also, a DTMF event recognition module 162 may be embedded within the memory 158. Further, a caller authentication module 164 may be embedded within the memory 158. FIG. 1 also shows that an interactive voice response (IVR) module 165 can be embedded within the memory 158. 20. In an alternative embodiment, the caller authentication module may be part of a third party identification verification system.

In a particular embodiment, the inbound/outbound dialing event management module 160 within the call server 136 can operate in order to establish calls to users when notification events are detected. Further, the DTMF event recognition module 162 can be used to handle DTMF recognition of input received from a user device, e.g., a telephone with touch-tone capabilities. Moreover, the caller authentication module 164 can interact with other components within the monitoring system, e.g., the user account database 140, in order to provide security validation such as telephone number verification or PIN verification. Additionally, the modules 160, 162, 164 within the call server 136 can operate with other components within the monitoring system 102 in order to handle one or more user sessions at the vender websites.

As depicted in FIG. 1, the voice mail notification server 138 can include a processor 166 and a computer readable medium, e.g., a memory 168, that is accessible to the processor 166. In a particular embodiment, one or more software applications or modules may be embedded within the memory 168 of the voice mail notification server 138. For example, a voice mail notification event handling module 170 can be embedded within the memory 168. Moreover, a voice mail storage module 172 can be embedded within the memory 168. A GSM to MPEG layer-3 (MP3) conversion module 174 can also be embedded within the memory 168.

In a particular embodiment, the voice mail notification event handling module 170 handles the distribution of non-live audio notifications, e.g., to voice mail systems. Further, the GSM to MP3 conversion module 174 can be used to convert GSM audio files to MP3 audio files. Additionally, the voice mail storage module 172 can be used to store various audio notifications that can be broadcast to users that are registered with the monitoring system 102.

In an exemplary, non-limiting embodiment, the account server 147 interacts with the call server 136 and a commerce interface 173. In a particular embodiment, the account server 147 can act as a “virtual user” for the vender websites when a registered user has been authenticated by the call server 136. Further, the account server 147 receives DTMF inputs, e.g., from a user via the call server 136, and translates the DTMF inputs to outbound Web events on a per vendor basis. For example, a user may press a “1” at a keypad of the user telephone and the account server can translate that response to an instruction to an auction website to increase a bid by one increment. Additionally, the account server 147 receives inputs from the vender websites and translates the inputs into audible phone events. Also, the account server 147 can translate the inputs into audible menus that can be broadcast to a registered user.

The commerce interface 173 may be implemented as an application programming interface (API) that can interact with the account server 147 and the vender interface module 116 at the vender server 104 in order to receive data representative of purchasing events and bidding events.

As illustrated in FIG. 1, the user account database 140 can include user registration data 176, watch list data 178, and site specific credentials 180. Also, as shown in FIG. 1, the user history database 142 can include transaction history data 182, historical price data 184, and historical availability data 186. The caller rules database 144 can include one or more event triggers 188, i.e., notification events. For example, the notification events can include the offer for sale of a particular item at a particular vendor website at a target price or the imminent end of an auction for a sought after item that a user has placed a bid.

In a particular embodiment, the caller rules database 144 can also include one or more contact rules 190 and one or more caller rules 192. The contact rules 190 can indicate the manner in which a registered user is to be contacted and a user defined order of calling a plurality of different contact numbers for the user. Further, the caller rules 192 can include user defined rules that will always control the action of the monitoring system when acting as a “virtual user.” For example, when a particular item is offered for sale, the user can specify for the monitoring system to automatically purchase the item at the asking price. Thereafter, the monitoring system can contact the user to indicate that the item has been purchased. In an alternative embodiment, the data provided by the databases 140, 142, 144 can be stored in a single database that is accessible to one or more of the other components within the monitoring system 102.

Each of the servers described above is a processing element that can be a server, as described, or a process. Further, any number or combination of the modules described above can be stored and executed within a single processing element or multiple processing elements in communication with each other.

In a particular embodiment, as shown in FIG. 1, the monitoring system 102 is separate from the vender server 104. However, in another particular embodiment, a portion of the monitoring system 102, or the entire monitoring system 102, can be embedded within the vender server 104. Additionally, in another particular embodiment, the monitoring system 102 can be directly coupled to the vendor server 104. Accordingly, any monitoring can be performed by the vendor server 104. Further, the vendor server 104 can contact one or more users directly. Alternatively, the vendor server 104 can instruct a third party, e.g., the VoIP server 108, to contact one or more users.

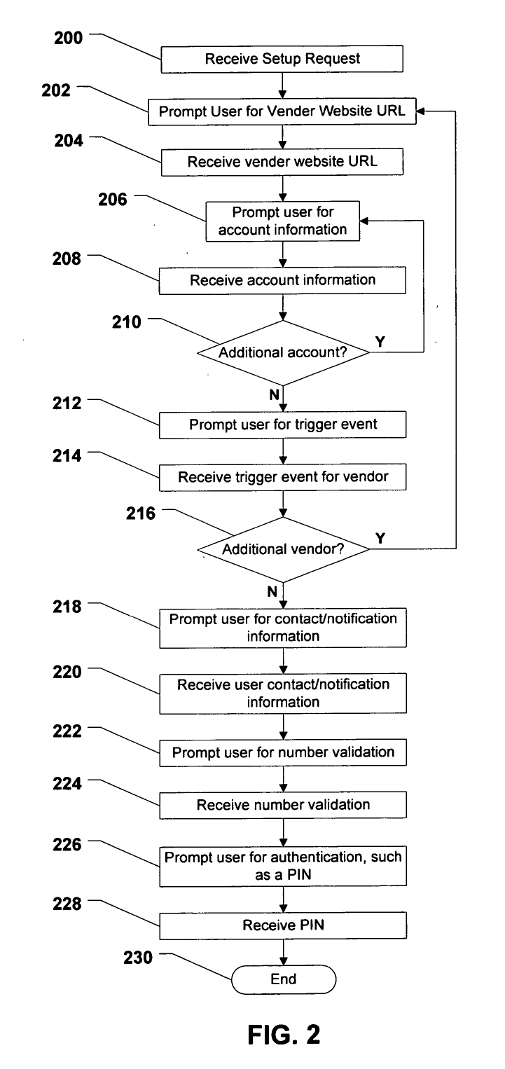

Referring to FIG. 2, a method of configuring a user account at the monitoring system is shown and commences at block 200. At block 200, the monitoring system receives a set up request from a user. At block 202, the user is prompted for a vendor website (URL). Moving to block 204, the monitoring system receives the vendor website URL from the user.

At block 206, the monitoring system prompts the user for account information, e.g., information concerning the user account with the vendor website. In a particular embodiment, the user account information can include a user account name, a user account number, and a user password. Moving to block 208, the system receives the user account information. Thereafter, at decision step 210, the system prompts the user to determine whether the user has an additional account with the vendor website. If so, the method returns to block 206 and continues as described.

If the user does not have an additional account with the vendor website, the method proceeds to block 212 and the user is prompted for a trigger event. In a particular embodiment, the trigger event can be a particular online auction for a particular item. Further, in a particular embodiment, the trigger event can be the release of a particular item, e.g., concert tickets, at a vendor website. Further, the trigger event can be a price decrease of a particular item, the release of a new book, the release of a new compact disk, etc. At block 214, the system receives the trigger event for the vendor.

Continuing to decision step 216, the system prompts the user to determine whether the user wishes to set up an account with another vendor. If the user indicates that the user would like to set up an account with another vendor, the method returns to block 202 and continues as described. If the user indicates that the user does not want to set up an account with another vendor, the method proceeds to block 218 and the system prompts the user for contact information or notification information. In a particular embodiment, the contact information or notification information can include a telephone number, e.g., a cellular telephone number, a mobile telephone number, or a public switched telephone network (PSTN) telephone number. At block 220, the system receives the user contact information or notification information.

Proceeding to block 222, the system prompts the user for number validation. At block 224, the system receives the number validation from the user. Next, at block 226, the system can prompt the user for an authentication, e.g., a personal identification number (PIN), that can be associated with the user account at the monitoring system. At block 228, the system receives the PIN from the user. The method then ends at state 230. Accordingly, the method described above can be used by a user to register with the monitoring system. Further, based on the information input to the monitoring system the user can be alerted when any of the trigger events input to the monitoring system occur at one or more vendor websites.

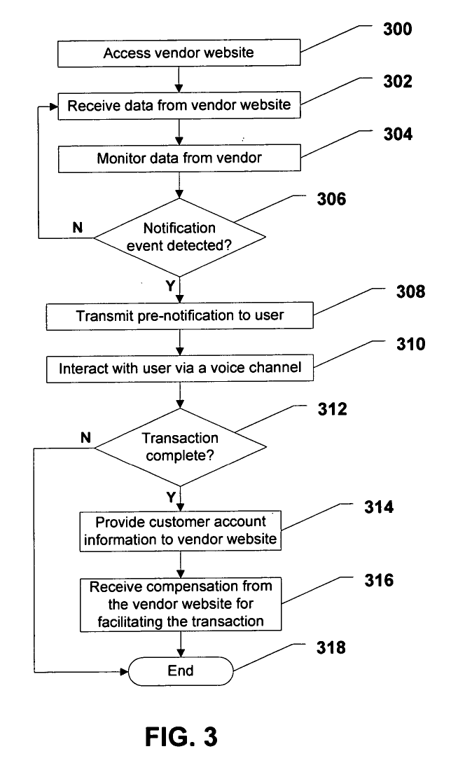

Referring to FIG. 3, a method of monitoring a vendor website for a trigger event is shown. Beginning at block 300, the monitoring system accesses the vendor website, e.g., via the Internet. At block 302, the monitoring system receives data from the vendor website. Next, at block 304, the monitoring system monitors the data from the vendor website. Moving to decision step 306, the monitoring system determines whether a notification event is detected based on the data received from the vendor website. If a notification event is not detected, the method returns to block 302 and continues as described herein. In a particular embodiment, the monitoring system can detect a notification event by monitoring the data received from the vender website for one or more of the triggers input by the user, e.g., a imminent end of an auction and a price decrease of a product.

On the other hand, if a notification event is detected, the method proceeds to block 308 and the monitoring system transmits a pre-notification message to the user. Next, at block 310 the monitoring system interacts with a user via a voice channel. In a particular embodiment, the pre-notification message can be sent to the user a predetermined time before the interaction with the user, e.g., thirty minutes prior to the interaction. Additionally, the pre-notification message can be sent to the user via a short messaging system (SMS), an email system, or an alphanumeric paging system. Also, in a particular embodiment, the pre-notification message can include the exact time that the interaction with the user is scheduled, the subject of the interaction, and other relevant information, e.g., a bid status, an auction status, a time remaining for the auction, etc. Further, in an exemplary, non-limiting embodiment, the interaction with the user can be facilitated using an interactive voice response (IVR) module at the monitoring system.

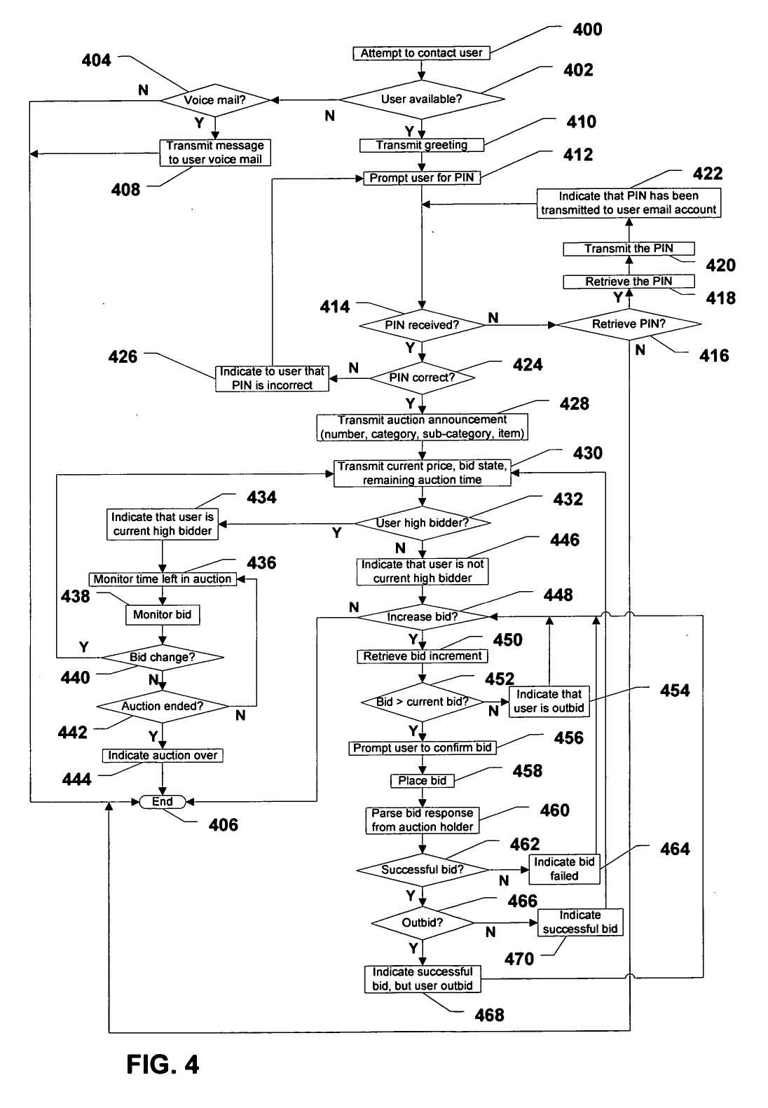

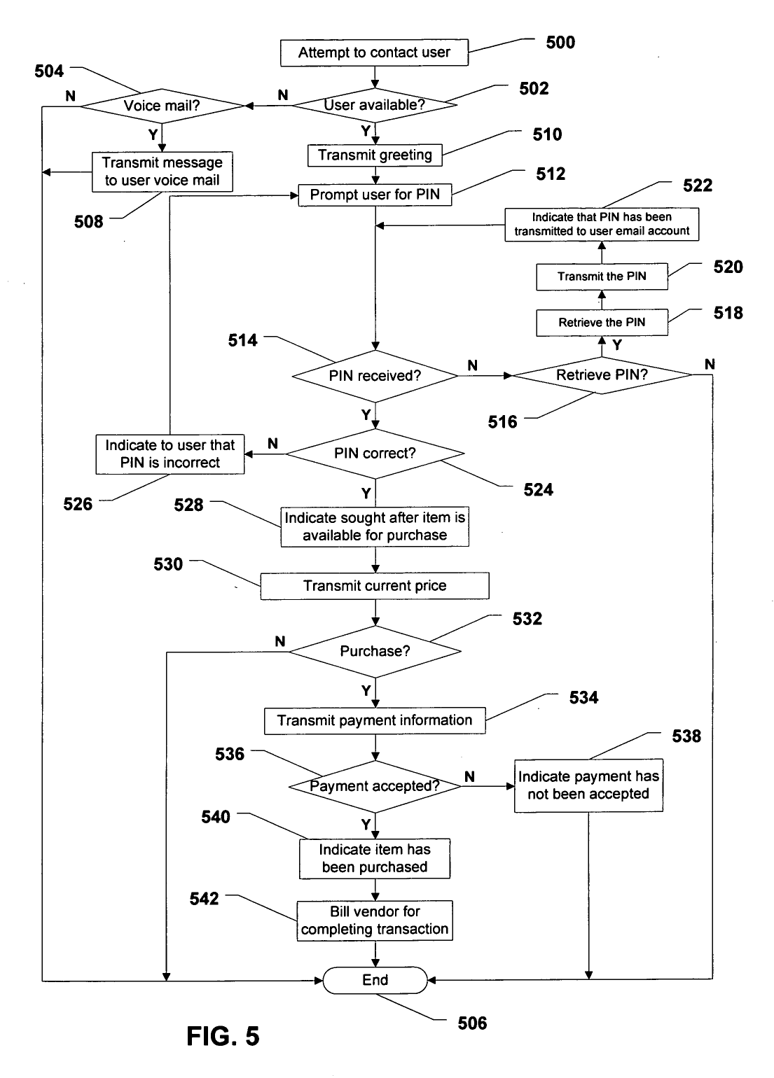

FIG. 4 depicts an exemplary method of interacting with a user that is registered with an auction website. FIG. 5 depicts an exemplary method of interacting with a user that is registered with an e-commerce website offering products for sale at set pricing.

Returning to FIG. 3, at decision step 312, the monitoring system determines whether the transaction has been completed, e.g., whether the user has purchased an item associated with the notification event or whether an auction associated with the notification event has ended. If the transaction is completed, the method proceeds to block 314 and the monitoring system provides customer account information to the vendor website. In a particular embodiment, the account information can include a login identification and a password. Further, in a particular embodiment, the account information can include an affiliate identification, which can be used to track successful bids and successful transactions. In another embodiment, the account information can include billing information, e.g., an account number, a credit card number, etc.

At block 316, the monitoring system receives compensation from the vendor website for facilitating the transaction. The method then ends at state 318. In a particular embodiment, the monitoring system can be compensated via an affiliate program associated with the vendor website. For example, an affiliate program identification can be tracked and the monitoring system can be credited for transactions. Additionally, in a particular embodiment, a transaction may include a completed purchase of an item. Alternatively, a transaction may include a successful bid for an item at an auction website. Returning to decision step 312, if the transaction is not completed, e.g., the user has decided not to purchase the item associated with the notification event, the method ends at state 318.

In a particular embodiment, the monitoring system can monitor the number of successful transactions and determine the rate at which successful transactions occur. As such, the monitoring system can further target particular users that are prone to completing transactions and purchasing goods. Further, the monitoring system can determine the percentage of total calls established that result in completed transactions that may be subject to billing to a vendor website. Alternatively, the monitoring system can determine the percentage of total calls that are compensated calls where the vendor website pays compensation either directly or through an affiliated payment plan in connection with user action made during the calls. In a particular embodiment, during operation, the percentage of total calls billed to one or more vendor websites is above a targeted percentage, e.g., ten percent, twenty percent, and fifty percent. The percentage of calls billed can be used to modify the monitoring system. For example, if the percentage of calls billed falls below the targeted percentage the monitoring system can modify the number of users that are called. Alternatively, the monitoring system can review the historical data for each user and only target those users that have a history of completing transactions via the monitoring system.

Referring to FIG. 4, a method of contacting a registered user regarding an auction website event is shown and commences at block 400. At block 400, the monitoring system attempts to contact a registered user over a voice channel, such as a cellular telephone. Next, at decision step 402, the monitoring system determines whether the user is available, i.e., has the user answered the telephone. If the user is not available, the method proceeds to decision step 404 and the monitoring system determines whether a voice mail system answers the call from the monitoring system. If not, the method ends at state 406. Otherwise, if a voice mail system answers the call from the monitoring system, the method continues to block 408 and the monitoring system transmits an audio message, e.g., an MP3 message, to the user voice mail. The method then ends at state 406.

Returning to decision step 402, when the user is available, the method proceeds to block 410 and the monitoring system transmits an audio greeting to the user 410. Thereafter, at step 412, the monitoring system prompts the user for a PIN in order to verify the user's identity. Proceeding to decision step 414, the monitoring system determines whether a PIN is received.

When a PIN is not received, the monitoring system prompts the user to determine whether the user would like the monitoring system to retrieve the PIN. If the user indicates that the user does not want the monitoring system to retrieve the PIN, the method ends at state 406. Conversely, when the user indicates to the monitoring system that the user does want the monitoring system to retrieve the PIN, the method proceeds to block 418 and the monitoring system retrieves the user PIN. Next, at block 420, the monitoring system transmits the user PIN to the user email account. At block 422, the monitoring system indicates that the PIN has been transmitted to the user email account.

Returning to decision step 414, when a PIN is received from the user, the method proceeds to decision step 424 and the monitoring system determines whether the PIN is correct. If the PIN is incorrect, the method moves to block 426 and the monitoring system indicates to the user that the PIN is incorrect. The method then returns to block 412 and continues as described herein.

When a correct PIN is received at decision step 424, the method continues to block 428 and the monitoring system transmits an auction announcement to the user, e.g., by transmitting an audio message to the user. In a particular embodiment, the auction announcement can include the number of the auction, the category of the auction, the sub-category of the auction, and the name of the item. Thereafter, at block 430, the monitoring system transmits the current price of the item, the current bid state, and the remaining auction time to the user. In a particular embodiment, the monitoring system can contact the user when the remaining auction time is less than ten minutes, e.g., six minutes, three minutes, etc. Further, in an alternative embodiment, a time remaining for the auction can be transmitted to the user in response to the user inputting a request for the time remaining, e.g., using a keypad at a telephone. In another alternative embodiment, the time remaining can be dynamically injected into a phone session in order to give real-time updates concerning the time remaining for the auction or a quantity remaining for a particular item.

Moving to decision step 432, the monitoring website determines whether the user the high bidder. If the user is the high bidder, the method continues to block 434 and the monitoring system indicates to the user that the user is the high bidder. At block 436, the monitoring system monitors the time remaining in the auction. Next, at block 438, the monitoring system monitors the bid. Proceeding to decision step 440, the monitoring system determines whether the bid has changed. If the bid changes, the method returns to block 430 and continues as described.

On the other hand, if the bid has not changed, the method moves to decision step 442 and the monitoring system determines whether the auction has ended. If the auction has not ended, the method returns to block 436 and continues as described herein. When the auction ends, the method moves to block 444 and the monitoring system indicates that the auction has ended. The method then ends at state 406.

Returning to decision step 432, if the user is not the high bidder, the method proceeds to block 446 and the monitoring system indicates that the user is not the high bidder. Next, at decision step 448, the monitoring system prompts the user to determine whether the user would like to increase his or her bid. If the user does not want to increase the bid, the method ends at state 406. When the user wants to increase the bid, the method moves to block 450 and the monitoring system retrieves the bid increment from the auction website. In a particular embodiment, the monitoring system can increase the user's bid to the user's maximum bid.

In a particular embodiment, the monitoring system determines real-time state information, such as high-bid status, through interaction with the auction website. For example, the time remaining for an auction can be managed at the auction website and the monitoring system can periodically poll the auction website in order to determine the time remaining.

Proceeding to decision step 452, the monitoring system determines whether the user's bid is greater than the current bid. If the user's bid is not greater than the current bid, the method proceeds to block 454 and the monitoring system indicates that the user is still outbid. The method returns to decision step 448 and continues as described. At decision step 452, when the user's bid is greater than the current bid, the method moves to block 456 and the monitoring system prompts the user to confirm the bid. Next, at block 458, the monitoring system places the bid for the user.

Continuing to block 460, the monitoring system parses a bid response received from the auction website. At decision step 462, the monitoring system determines whether the user's bid is successful. If the user's bid is not successful, the method proceeds to block 464 and the monitoring system indicates that the user's bid has failed. The method then returns to decision step 448 and continues as described herein.

At decision step 462, if the user's bid is successful, the method proceeds to decision step 466 and the monitoring system determines whether the user has been outbid. If the user is outbid, the method proceeds to block 468 and the monitoring system indicates to the user that the bid is successful, but the user has been outbid. The method then returns to decision step 448 and continues as described. Conversely, if the user is not outbid, the method proceeds to block 470 and the monitoring system indicates to the user that the user's bid was successful. Then, the method returns to block 430 and continues as described.

Referring to FIG. 5, a method of contacting a registered user about an e-commerce website is shown and commences at block 500. At block 500, the monitoring system attempts to contact a registered user via a telephone, e.g., a cellular telephone or a landline telephone. Next, at decision step 502, the monitoring system determines whether the user is available, i.e., has the user answered the call. If the user is not available, the method proceeds to decision step 504 and the monitoring system determines whether a voice mail system answers the call from the monitoring system. If not, the method ends at state 506. Otherwise, if a voice mail system answers the call from the monitoring system, the method continues to block 508 and the monitoring system transmits an audio message, e.g., an MP3 message, to the user voice mail. The method then ends at state 506.

Returning to decision step 502, when the user is available, the method proceeds to block 510 and the monitoring system transmits an audio greeting to the user 510. Thereafter, at step 512, the monitoring system prompts the user for a PIN in order to verify the user's identity. Proceeding to decision step 514, the monitoring system determines whether a PIN is received.

When a PIN is not received, the monitoring system prompts the user to determine whether the user would like the monitoring system to retrieve the PIN. If the user indicates that the user does not want the monitoring system to retrieve the PIN, the method ends at state 506. Conversely, when the user indicates to the monitoring system that the user does want the monitoring system to retrieve the PIN, the method proceeds to block 518 and the monitoring system retrieves the user PIN. Next, at block 520, the monitoring system transmits the user PIN to the user email account. At block 522, the monitoring system indicates that the PIN has been transmitted to the user email account.

Returning to decision step 514, when a PIN is received from the user, the method proceeds to decision step 524 and the monitoring system determines whether the PIN is correct. If the PIN is incorrect, the method moves to block 526 and the monitoring system indicates to the user that the PIN is incorrect. The method then returns to block 512 and continues as described.

When a correct PIN is received at decision step 524, the method continues to block 528 and the monitoring system indicates that a sought after item, e.g., an item on a watch list or wish list established by the user with the monitoring system or the vendor website, is available for purchase or is at a target price desired by the user. Next, at block 530, the monitoring system transmits a current price to the user. In a particular embodiment, the monitoring system communicates with the user by transmitting audio messages to the user. Moving to decision step 532, the monitoring system prompts the user in order to determine whether the user wants to purchase the sought after item. If the user does not want to purchase the sought after item, the method ends at state 506.

On the other hand, if the user indicates that the user wants to purchase the sought after item, the method proceeds to block 534 and the monitoring system transmits the user payment information, previously supplied to the monitoring system, to the vender website. Thereafter, at block 536, the monitoring system determines whether payment has been accepted by the vendor website. If payment is not accepted, the method proceeds to block 538 and the monitoring system indicates to the user that payment has not been accepted by the vendor website. The method then ends at state 506. In a particular embodiment, payment can be facilitated using previously stored payment data, e.g., using a “one click” shopping mechanism at the vendor website.

When payment is accepted, the method proceeds to block 540 and the monitoring system indicates to the user that the sought after item has been purchased. Proceeding to block 542, the monitoring system bills the vendor website for completing the transaction. The method then ends at state 506.

In one or more of the methods disclosed, a user is authenticated by inputting a PIN. However, the user can input one or more alternative authentication inputs. For example, the authentication input can be a biometric input, such as a voice input, a fingerprint scan, a palm scan, an iris scan, a retinal scan, facial mapping, infrared pattern matching, etc. Alternatively, the authentication can be performed using a physical token device, e.g., a passkey or a universal serial bus (USB) dongle.

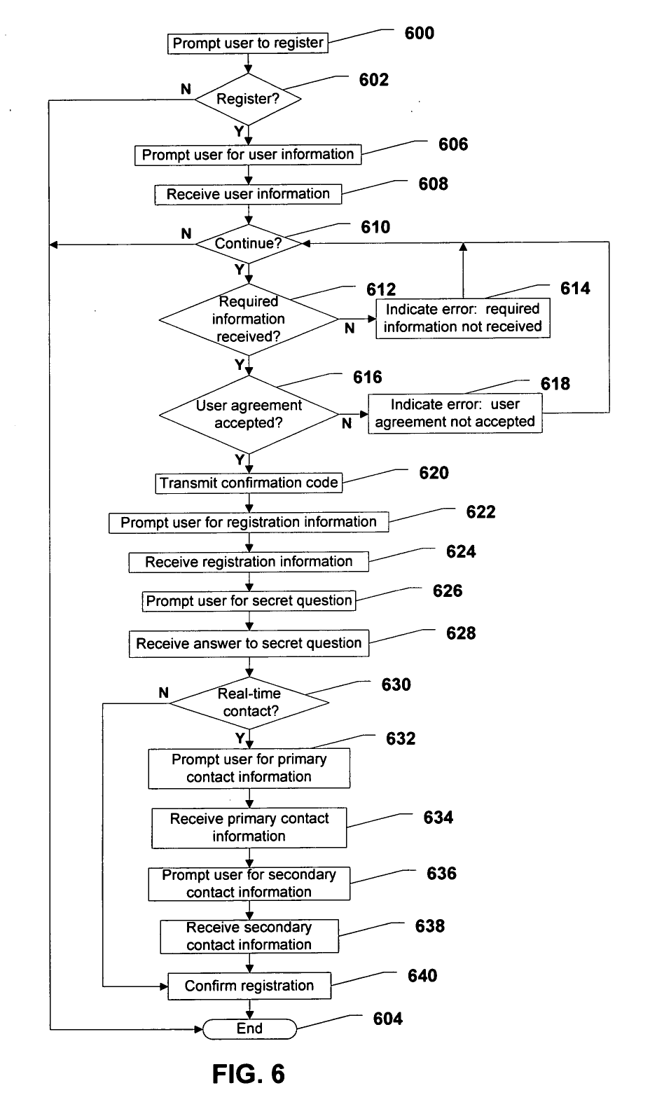

Referring to FIG. 6, a method of establishing a user account with a vender system is shown and commences at block 600. At block 600, the vendor website prompts the user to register with the vendor website. Next, at block 602, the vendor website determines whether an indication to register with the vendor website is received. When an indication to not register is received, the method ends at state 604. On the other hand, when an indication to register with the vendor website is received, the method moves to block 606 and the vendor website is prompted for user information. At block 608, the vendor website receives the user information. In a particular embodiment, the user information includes a first name, a last name, an address, a city, a state, a zip code, a country, a primary telephone number, a secondary telephone number, a date of birth, and an email address.

Proceeding to decision step 610, the vendor website determines whether a continue button is selected before a timeout period ends. If the continue button is not selected, the method ends at state 604. When the continue button is selected, the method moves to decision step 612 and the vendor website determines whether the required information is received from the user. If the required information is not received from the user, the method moves to block 614 and the vender website indicates an error to the user that all or some of the required information was not received from the user. The method then returns to decision step 610 and continues as described.

Returning to decision step 612, when the required information is received, the method continues to decision step 616 and the vendor website determines whether a user agreement is accepted by the user, e.g., by selecting a box next to a statement that affirms that the user has accepted the user agreement. If the user agreement is not accepted, the method proceeds to block 618 and the vendor website indicates an error to the user that the user agreement has not been accepted. The method then returns to decision step 610 and continues as described. At decision step 616, when the user agreement is accepted, the method continues to block 620 and the vendor website transmits a confirmation code.

Moving to block 622, the vendor website prompts the user for registration information. At block 624, the vendor website receives the user registration information. In a particular embodiment, the user registration information includes an identification, a password, an email address, and the confirmation code transmitted to the user. Further, the identification and the password can be selected by the user and approved by the vendor website.

At block 626, the vendor website prompts the user for a secret question. At block 628, the vendor website prompts the user for the answer to the secret question. In a particular embodiment, the secret question and answer can be used as a second level of security in order to verify the user's identity with the vendor website, e.g., when the user contacts the vendor website to modify one or more account settings.

Continuing to decision step 630, the vendor website prompts the user to determine whether the user would like to receive real-time product status updates, e.g., auction updates, via a voice channel provided by a wireless telephone or a land-line telephone. If the user wants to receive real-time product status updates, the method continues to block 632 and the vendor website prompts the user for primary contact information, e.g., a wireless telephone number. At block 634, the vendor website receives the primary contact information. Further, at block 636, the vendor website prompts the user for secondary contact information. At block 638, the vendor website receives the secondary contact information. Then, the vendor website confirms the registration at block 640 and the method ends at state 604.

Returning to decision step 630, when the user chooses not to receive real-time product updates, the method proceeds to block 640 and the vendor website confirms the user registration. The method then ends at 604. In a particular embodiment, the primary contact information can be the primary telephone number received above. Further, the secondary contact information can be the secondary telephone number received above. Alternatively, the user may want to contact via other telephone numbers not input with the user information.

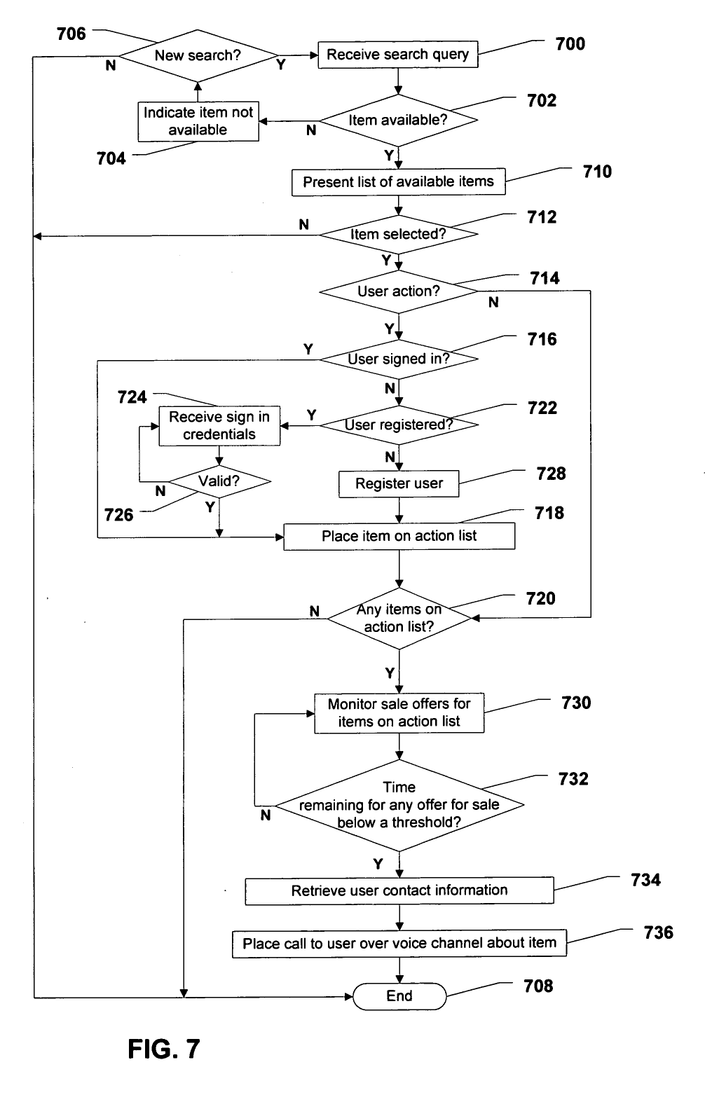

FIG. 7 illustrates a method of contacting a registered user about a product available at a vender website. Beginning at block 700, a vendor website receives a search query. At decision step 702, the vendor website determines whether an item is available based on the search query. If no item is available, the method moves to block 704 and the vendor website indicates that the item is not available. Moving to decision step 706, the vendor website determines whether a new search is received. If a new search is received, the method returns to block 700 and continues as shown. Otherwise, if a new search is not received, the method ends at state 708.

Returning to decision step 702, if one or more items that satisfy the search query are available, the method continues to block 710 and the vendor website presents a list of the items that satisfy the search query. At decision step 712, the vendor website determines if any items on the list are selected. If not, the method ends at state 708. On the other hand, if any items are selected, the method proceeds to decision step 714 and the vendor website determines whether any user action has been taken with respect to the selected items. In a particular embodiment, the user action can be a bid, a request to watch the item, or a best offer for the item.

When user action is taken with respect to a selected item, the method proceeds to decision step 716 and the vendor website determines whether the user is signed in. If the user is signed in, the method proceeds to block 718 and the selected item is placed on an action list. The method then moves to decision step 720.

Returning to decision step 716, when the user is not signed in, the method proceeds to decision step 722 and the vendor website determines whether the user is registered with the vendor website. If the user is registered, the method proceeds to block 724 and the vendor website receives the user registration credentials. At decision step 726, the vendor website determines whether the registration credentials are valid. If so, the method proceeds to block 718 and the selected item is placed on the action list. The method then moves to decision step 720. At decision step 726, if the registration credentials are invalid, the method returns to block 724 and continues as described herein. At decision step 722, if the user is not registered, the method proceeds to block 728 and the vendor website registers the user. The method then moves to decision step 720.

Returning to decision step 714, if no user action is taken with respect to a selected item, the method moves directly to decision step 720 and the vendor website determines whether there are any items on the user's action list, e.g., previously selected items and currently selected items. If there are not any items on the user's action list, the method ends at state 708. Conversely, if there are items on the user's action list, the method proceeds to block 730 and the vendor website monitors sale offers for the items on the action list.

Proceeding to decision step 732, the vendor website determines whether a time remaining for any offer of sale is below a predetermined threshold. If the time remaining for any offer of sale is not below the predetermined threshold, the method returns to block 730 and continues as illustrated in FIG. 7. On the other hand, if the time remaining for any offer of sale is below the predetermined threshold, the method continues to block 734 and the vendor website retrieves the user contact information. Thereafter, at block 736, the vendor website places a call regarding the item to the user over a voice channel. The method then ends at state 708. In a particular embodiment, the vendor website can contact the user using the method depicted in FIG. 4. In an alternative embodiment, the vendor website can contact the user using the method depicted in FIG. 5. Additionally, the vendor website can attempt to contact the user using the primary contact information first. If the user is unavailable via the primary contact information, the method attempts to contact the user using the secondary primary contact information.

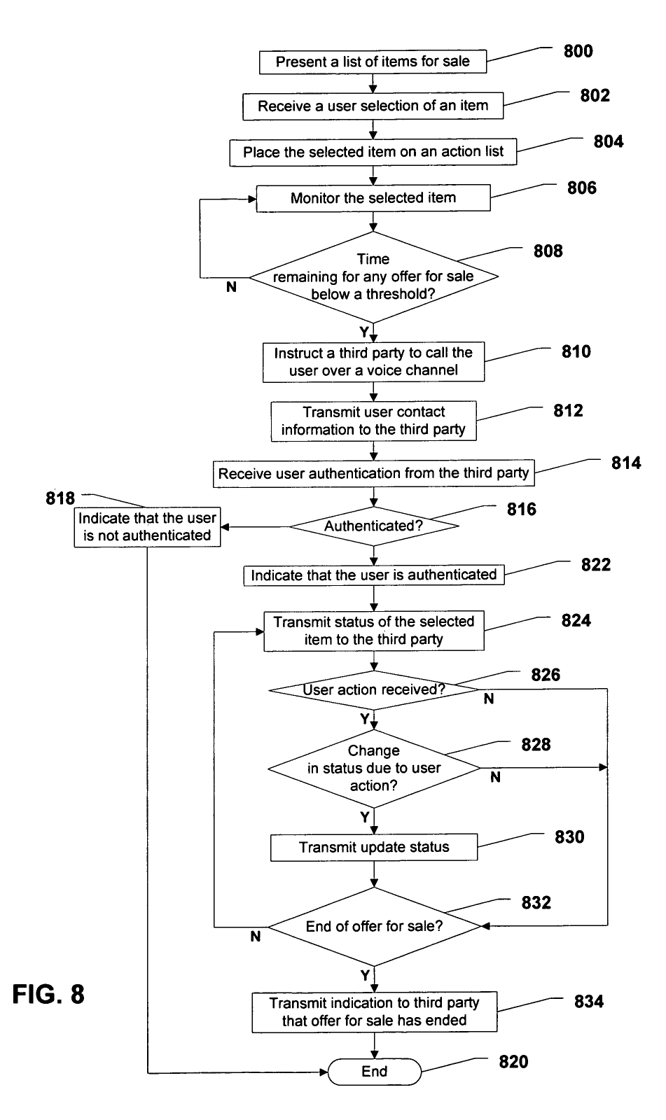

Referring to FIG. 8, an alternative method of contacting a registered user about a product available at a vender website is illustrated and commences at block 800. At block 800, a vendor website presents a list of items for sale. At block 802, the vendor website receives a selection of an item. Moving to block 804, the vendor website places the selected item on an action list 804, e.g., in response to a user action with respect to the selected item. The user action can be a bid for the selected item, a request to watch the selected item, or a best offer for the selected item.

Proceeding to block 806, the vendor website monitors the selected item. Next, at decision step 808, the vendor website determines whether a time remaining for any offer of sale is below a predetermined threshold. If the time remaining for any offer of sale is not below the predetermined threshold, the method returns to block 806 and continues as indicated in FIG. 8. On the other hand, if the time remaining for any offer of sale is below the predetermined threshold, the method continues to block 810 and the vendor website instructs a third party system to call the user over a voice channel. In a particular embodiment, the third party system can be a monitoring system or website.

At block 812, the vendor website transmits user contact information to the third party system. The user contact information can include primary contact information and secondary contact information. Moving to block 814, the vendor website receives user authentication from the third party system. At decision step 816, the vendor website determines whether the user is authenticated. If not, the method proceeds to block 818 and the vendor website indicates to the third party system that the user is not authenticated. The method then ends at state 820.

Returning to decision step 816, if the user is authenticated the method proceeds to block 822 and the vendor website indicates to the third party system that the user is authenticated. Then, at block 824, the vendor website transmits the status of the selected item to the third party system. Proceeding to decision step 826, the vendor website determines whether a user action is received from the third party system. If so, the method continues to decision step 828 and the vendor website determines whether the status of the selected item changes in response to the user action. If the status changes, the method moves to block 830 and the vendor website transmits and updated status to the third party system. Thereafter, the method continues to decision step 832. Returning to decision step 828, if the status of the selected item does not change in response to the user action, the method also proceeds to decision step 832.

At decision step 832, the vendor website determines whether the offer for sale for the selected item has ended. If not, the method returns to block 824 and continues as described. Otherwise, when the offer for sale ends, the method proceeds to block 834 and the vendor website transmits an indication to the third party system that the offer for sale for the selected item has ended. The method then ends at state 820. Returning to decision step 826, if no user action is received from the third party system, the method moves directly to decision step 832 and continues as shown.

The method shown in FIG. 8 indicates that that the user contact information is stored at the vendor website and transmitted to the third party system to be used to contact the user. Further, the method shown in FIG. 8 indicates that the user is authenticated at the vendor website. However, in an alternative embodiment, the user contact information can be stored at the third party system and the authentication can be performed at the third party system.

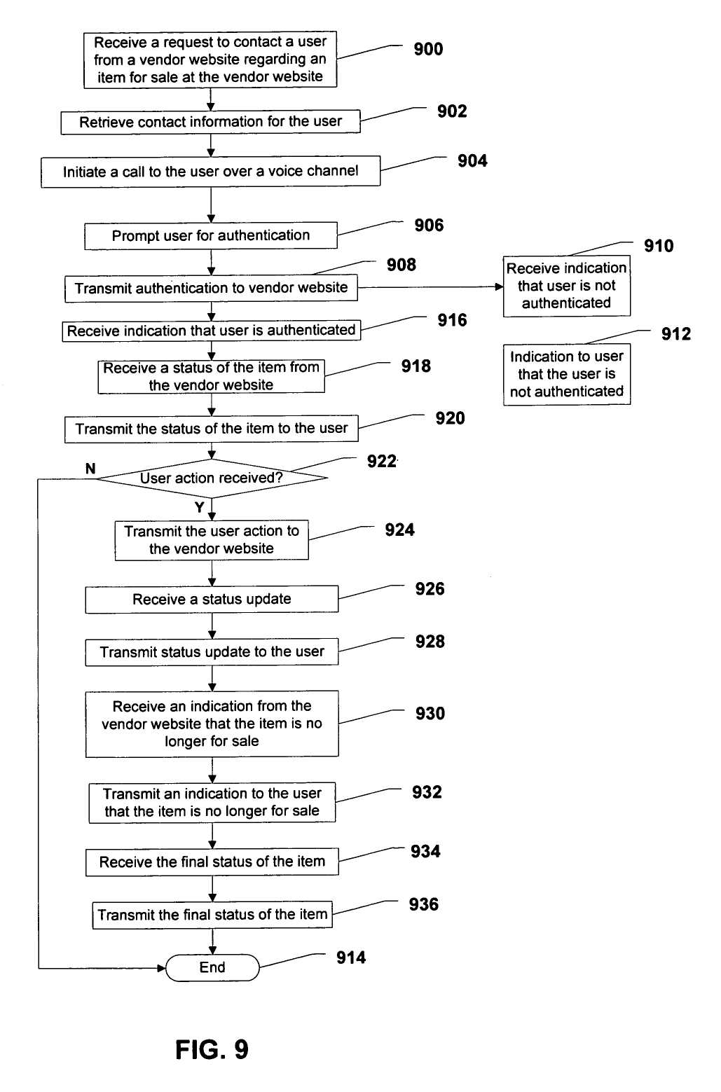

FIG. 9 illustrates yet another method of contacting a registered user about a product available at a vender website. Beginning at block 900, a third party system receives a request to contact a user from a vendor website regarding an item for sale at the vendor website. At block 902, the third party system retrieves contact information for the user, e.g., from a database coupled to the third party system or from the vendor website. Moving to block 904, the third party system initiates a call to the user over a voice channel. At block 906, the third party system prompts the user for authentication. Next, the third party system transmits the authentication to the vendor website.

In a particular embodiment, the third party system can receive one of two responses from the vendor website based on the authentication. For example, a first response occurs at block 910, wherein the third party system receives an indication from the vendor website that the user is not authenticated. At block 912, the third party system transmits the indication that the user is not authenticated to the user. The method then ends at state 914.

A second response by the vendor website to the user authentication occurs at block 916, wherein the third party system receives an indication from the vendor website that the user is authenticated. Thereafter, at block 918 the third party system receives a status of the item from the vendor website. At block 920, the third party system transmits the status of the item to the user. Continuing to decision step 922, the third party system determines whether a user action is received. If no user action is received, the method ends at state 914. On the other hand, if a user action is received, the method moves to block 924 and the third party system transmits the user action to the vendor website.

At block 926, the third party system receives a status update from the vendor website. Next, at block 928, the third party system transmits the status update to the user. Further, at block 930, the third party system receives an indication from the vendor website that the item is no longer for sale. At block 932, the third party system transmits an indication to the user that the item is no longer for sale.

Moving to block 934, the third party system receives the final status of the item. At block 936, the third party system transmits the final status of the item to the user. The method then ends at state 914.

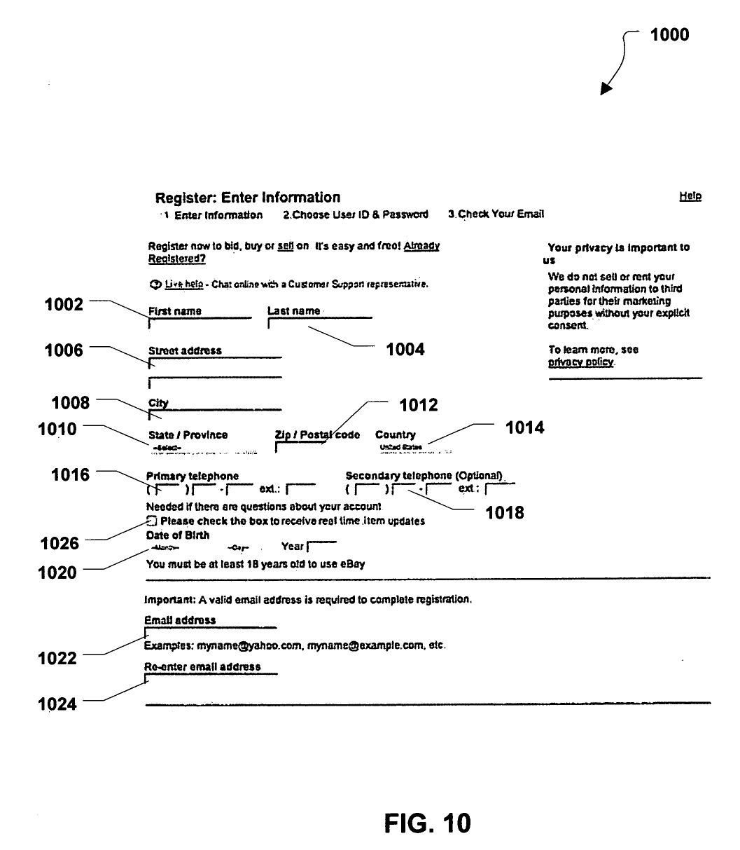

Referring to FIG. 10, a first registration screen is shown and is generally designated 1000. In an exemplary, non-limiting embodiment, as illustrated in FIG. 10, the first registration screen 1000 can include a first name input field 1002 and a last name input field 1004. In a particular embodiment, a user can input his or her first and last name to a vendor website via the first name input field 1002 and the last name input field 1004.

As further illustrated in FIG. 10, the first registration screen 1000 can include a street address input field 1006, a city input field 1008, a state input field 1010, a zip/postal code input field 1012, and a country input field 1014. In a particular embodiment, a user can input his or her address to the vendor website via the street address input field 1006, the city input field 1008, the state input field 1010, the zip/postal code input field 1012, and the country input field 1014.

FIG. 10 also shows that the first registration screen 1000 can include a primary telephone number input field 1016 and a secondary telephone number input field 1018 into which a user can input a primary telephone number and a secondary telephone number, respectively. In a particular embodiment, the input of the secondary telephone number can be optional. Additionally, the first registration screen 1000 can include a date of birth input field 1020 into which a user can input his or her birthday. Also, the first registration screen 1000 can include an email address input field 1022 and a redundant email address input field 1024 into which a user can enter and re-enter his or her email address.

FIG. 10 also shows that the first registration screen 1000 can include a real time item update selection field 1026. In a particular embodiment, a user can select the real time item update selection field 1026, e.g., by moving a cursor over the real time item update selection field 1026 and clicking on the real time item update selection field 1026 with a mouse or other input device, in order to indicate to the vendor website that the user would like to receive real time item updates. In a particular embodiment, the real time item updates can be transmitted over a voice channel provided by the primary telephone number or the secondary telephone number input via the first registration screen 1000.

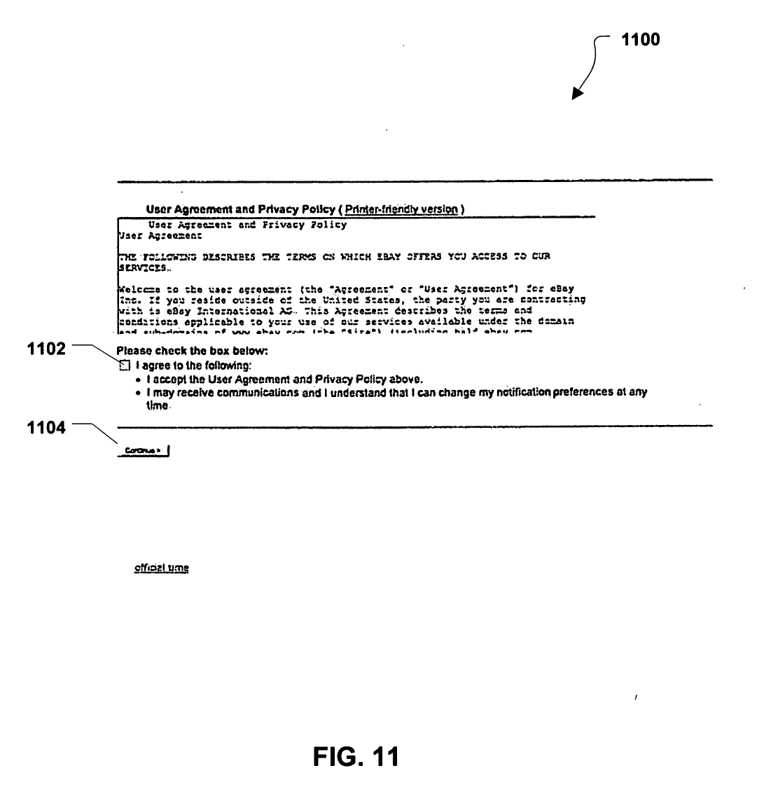

Referring to FIG. 11, a second registration screen is shown and is generally designated 1100. As illustrated in FIG. 11, the second registration screen 1100 can include a user agreement selection field 1102 and a continue button 1104. A user can indicate that he or she agrees with a user agreement provided by a vendor website by selecting the user agreement selection field 1102. Further, the user can continue a registration process by toggling the continue button 1104.

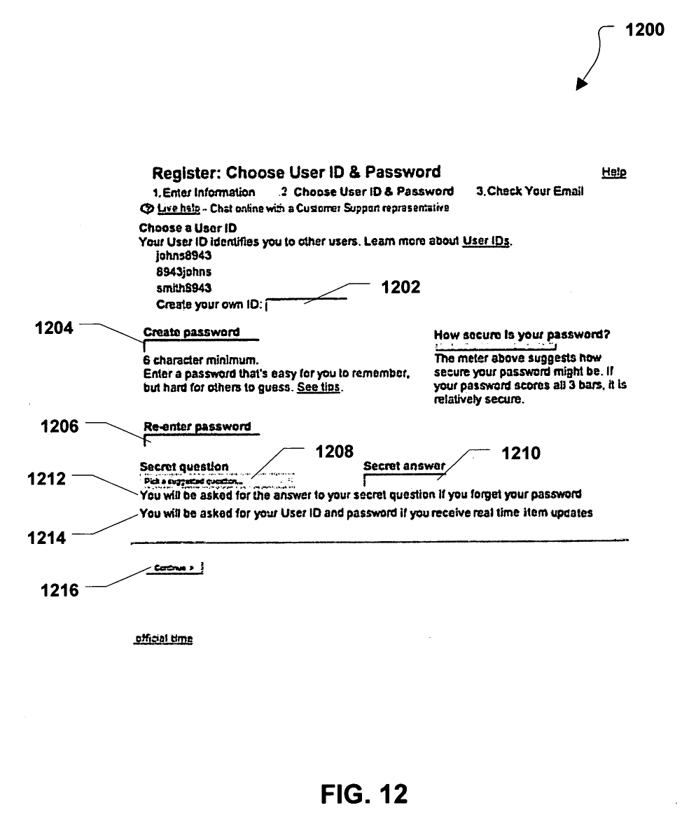

When the continue button 1104 is selected, a third registration screen can be presented to the user. FIG. 12 depicts an exemplary, non-limiting embodiment of a third registration screen that is generally designated 1200. As shown, the third registration screen 1200 can include an identification input field 1202, a password input field 1204, and a redundant password input field 1206. The user can input a user selected identification via the identification input field 1202. Further, the user can enter a user selected password and re-enter the user selected password via the password input field 1204 and the redundant password input field 1206.

As indicated in FIG. 12, the third registration screen 1200 can include a secret question selection menu 1208 and a secret answer input field 1210. The user can select a secret question from the secret question selection menu 1208 and input an answer to the selected secret question via the secret answer input field 1210. In a particular embodiment, the secret question can be: the user's mother's maiden name, the name of the street that the user grew up on, the name of the user's first school, the name of the user's pet, the user's father's middle name, the user's school mascot, or any other question that has an answer that is typically known only by the user.

FIG. 12 further indicates that the third registration screen 1200 includes a first user indication 1212 that indicates to the user, “You will be asked for the answer to your secret question if you forget your password.” Also, the third registration screen 1200 includes a second user indication 1214 that indicates to the user, “You will be asked for your User ID and password if you receive real-time item updates.” Additionally, the third registration screen 1200 includes a continue button 1216 that can be toggled in order to complete the registration process.

With the configuration of structure described above, the system and method of event triggered voice call origination provides a way to one or more auctions and contact one or more users as the end of an auction nears. For example, a user can query an auction website for a particular item. In response to the user query, the auction website can present a list of matching items. Further, the auction website can place a selected item on an action list if the user decides to bid on the item, input a best offer for the item, place the item on a watch list, or place the item on a wish list. As the time remaining for the auction winds down, the auction website can contact the user about the item and prompt the user to take action with respect to the item, e.g., increase a bid amount. The user can interact with the auction website using a communication device, e.g., a wireless telephone, a land-line telephone, or a VoIP telephone. In an alternative embodiment, the auction website can instruction a third party system to contact the user as the auction draws to a close and the third party system can interact with the user and only input user actions to the auction website.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
presenting a list of items for sale;
receiving a user selection of an item from the list of items for sale;
placing the selected item on an action list in response to a user action;
monitoring the selected item on the action list;
placing a call to the user over a voice channel before an end of an offer for sale of the selected item; and
authenticating the user.

2. The method of claim 1, further comprising determining whether the user is registered at a web server, before placing the selected item on the action list.

3. The method of claim 2, further comprising receiving one or more sign-in credentials from the user.

4. The method of claim 3, further comprising registering the user after determining that the user is not registered.

5. The method of claim 1, wherein the user action is: a request to place the selected item on a watch list, a request to place the selected item on a wish list, a bid, or a best offer.

6. The method of claim 5, wherein the action list is: a watch list, a wish list, a bid list, or a best offer list.

7. The method of claim 1, further comprising retrieving primary contact information associated with the user from a database.

8. The method of claim 7, further comprising retrieving secondary contact information associated with the user from the database.

9. The method of claim 8, further comprising attempting to contact the user using the primary contact information.

10. The method of claim 9, further comprising attempting to contact the user using the secondary contact information after attempting to contact the user using the primary contact information.

11. The method of claim 1, wherein the list of items for sale is presented based on a search query.

12. A method of registering a user at an e-commerce website, the method comprising:
receiving user information;
receiving account information from the user;
prompting the user to select an option for real-time communication over a voice channel regarding one or more user selected items available via the e-commerce website, wherein the real-time communication occurs before an end of an offer for sale of the one or more user selected items; and
prompting the user to select an option for authenticating the user when the real-time communication is received.

13. The method of claim 12, further comprising receiving primary contact information from the user.

14. The method of claim 13, wherein the primary contact information is a first telephone number.

15. The method of claim 14, wherein the first telephone number is a plain old telephone service (POTS) telephone number or a wireless telephone number.

16. The method of claim 13, further comprising receiving secondary contact information from the user.

17. The method of claim 16, wherein the secondary contact information is a second telephone number.

18. The method of claim 17, wherein the second telephone number is a plain old telephone service (POTS) telephone number or a wireless telephone number.

19. The method of claim 12, wherein the user information includes at least one of the following: a first name, a last name, an address, a primary telephone number, a secondary telephone number, a date of birth, and an email address.

20. The method of claim 12, wherein the account information includes at least one of the following: a user identification, a user password, an email address, a confirmation code, a secret question, and an answer to the secret question.

21. A method, comprising:
presenting a list of items for sale;
receiving a user selection of an item from the list of items for sale;
placing the selected item on an action list in response to the user selection; and
instructing a third party to place a call to the user over a voice channel before an end of an offer for sale of the selected item.

22. The method of claim 21, further comprising transmitting user contact information to the third party.

23. The method of claim 22, further comprising receiving a user authentication.

24. The method of claim 23, further comprising authenticating the user.

25. The method of claim 24, further comprising transmitting a status of the selected item to the third party.

26. The method of claim 25, further comprising receiving a user action from the third party.

27. The method of claim 26, wherein the user action is: a bid, a best offer, or a purchase request.

28. The method of claim 26, further comprising updating the status of the selected item based on the user action.

29. The method of claim 28, further comprising transmitting an updated status of the selected item to the third party.

30. A method, comprising:
receiving a request to contact a user from a vendor website server regarding an item offered for sale at the vendor website server;
retrieving contact information for the user;
initiating a call to the user over a voice channel; and
requesting an authentication credential from the user.

31. The method of claim 30, further comprising authenticating the user.

32. The method of claim 30, further comprising transmitting the authentication credential to the vendor website server and receiving an indication that the user is authenticated.

33. The method of claim 32, further comprising receiving a status of the item from the vendor website.

34. The method of claim 33, further comprising transmitting a status of a selected item to the user.

35. The method of claim 34, further comprising receiving a user action.

36. The method of claim 35, wherein the user action is: a bid, a best offer, or a purchase request.

37. The method of claim 36, further comprising transmitting the user action to the vendor website.

38. The method of claim 37, further comprising receiving an updated status of the selected item in response to the user action.

39. The method of claim 38, further comprising transmitting the updated status to the user.

40. The method of claim 39, further comprising receiving an end of sale indication for the vendor website that the selected item is no longer for sale.

41. The method of claim 40, further comprising transmitting the end of sale indication to the user.

42. A server comprising:
a computer readable medium accessible to a processor, the computer readable medium comprising a computer program, wherein the computer program comprises:
instructions to receive a user action related to an item available for sale;
instructions to place the item on an action list in response to the user action;
instructions to contact a user in real-time via a voice channel before an end of an offer for sale of the item; and
instructions to authenticate the user.

43. The server of claim 42, wherein the user action is: a request to place the item on a watch list, a request to place the item on a wish list, a bid, or a best offer.

44. The server of claim 42, wherein the action list is a: watch list, a wish list, a bid list, or a best offer list.

45. The server of claim 42, further comprising a vendor interface module embedded within the computer readable medium, wherein the vendor interface module connects the user to the server.

46. The server of claim 45, further comprising an inventory module embedded within the computer readable medium, wherein the inventory module tracks an inventory of items for sale.

47. The server of claim 46, further comprising a user history and watch list module embedded within the computer readable medium, wherein the user history and watch list module tracks a shopping and bidding history of the user and wherein the user history and watch list module tracks at least one item.

48. The server of claim 47, further comprising a transaction processing module embedded within the computer readable medium, wherein the transaction processing module processes one or more user transactions.
